(19) United States
(12) Patent Application Publication
(10) Pub. No.: US 2024/0313929 A1
(43) Pub. Date: Sep. 19, 2024

(54) CONSTRUCTING A HARQ-ACK CODEBOOK

(71) Applicant: Lenovo (Singapore) Pte. Ltd., New Tech Park (SG)

(72) Inventors: Hyejung Jung, Northbrook, IL (US); Vijay Nangia, Woodridge, IL (US)

(21) Appl. No.: 18/681,225

(22) PCT Filed: Jul. 8, 2022
(86) PCT No.: PCT/IB2022/057020

§ 371 Date: Feb. 5, 2024

Related U.S. Application Data
(60) Provisional application No. 63/229,930, filed on Aug. 5, 2021.

(51) Int. Cl. H04L 5/00; H04L 1/1812

(52) U.S. Cl. CPC H04L 5/0055; H04L 1/1816

(57) ABSTRACT

Apparatuses, methods, and systems are disclosed for constructing a HARQ-ACK codebook. One method (500) includes detecting (502) a DCI format including DCI indicating HARQ-ACK retransmission. The DCI indicating HARQ-ACK retransmission includes an indication of at least one HARQ-ACK transmission occasion for retransmission. The method (500) includes constructing (504) a HARQ-ACK codebook based on the indication of the at least one HARQ-ACK transmission occasion for retransmission. The method (500) includes transmitting (506) the HARQ-ACK codebook in a first slot.

### CROSS-REFERENCE TO RELATED APPLICATIONS

This application claims priority to U.S. Patent Application Ser. No. 63/229,930 entitled “APPARATUSES, METHODS, AND SYSTEMS FOR FLEXIBLE RETRANSMISSION OF CANCELED HARQ-ACK FEEDBACK” and filed on Aug. 5, 2021 for Hyejung Jung et al., which is incorporated herein by reference in its entirety.

### FIELD

The subject matter disclosed herein relates generally to wireless communications and more particularly relates to constructing a HARQ-ACK codebook.

### BACKGROUND

In certain wireless communications networks, HARQ-ACK feedback may be transmitted. In such networks, the HARQ-ACK feedback may be retransmitted.

### BRIEF SUMMARY

Methods for constructing a HARQ-ACK codebook are disclosed. Apparatuses and systems also perform the functions of the methods. One embodiment of a method includes detecting, at a UE, a DCI format including DCI indicating HARQ-ACK retransmission. The DCI indicating HARQ-ACK retransmission includes an indication of at least one HARQ-ACK transmission occasion for retransmission. In some embodiments, the method includes constructing a HARQ-ACK codebook based on the indication of the at least one HARQ-ACK transmission occasion for retransmission. In certain embodiments, the method includes transmitting the HARQ-ACK codebook in a first slot.

One apparatus for constructing a HARQ-ACK codebook includes a user equipment. In some embodiments, the apparatus includes a processor to: detect a DCI format including DCI indicating HARQ-ACK retransmission, wherein the DCI indicating HARQ-ACK retransmission includes an indication of at least one HARQ-ACK transmission occasion for retransmission; and construct a HARQ-ACK codebook based on the indication of the at least one HARQ-ACK transmission occasion for retransmission. In various embodiments, the apparatus includes a transmitter to transmit the HARQ-ACK codebook in a first slot.

Another embodiment of a method for constructing a HARQ-ACK codebook includes transmitting, from a network device, a DCI format including DCI indicating HARQ-ACK retransmission. The DCI indicating HARQ-ACK retransmission includes an indication of at least one HARQ-ACK transmission occasion for retransmission. In some embodiments, the method includes receiving a HARQ-ACK codebook in a first slot. The HARQ-ACK codebook is constructed based on the indication of the at least one HARQ-ACK transmission occasion for retransmission.

Another apparatus for constructing a HARQ-ACK codebook includes a transmitter to transmit a DCI format including DCI indicating HARQ-ACK retransmission. The DCI indicating HARQ-ACK retransmission includes an indication of at least one HARQ-ACK transmission occasion for retransmission. In some embodiments, the apparatus includes a receiver to receive a HARQ-ACK codebook in a first slot. The HARQ-ACK codebook is constructed based on the indication of the at least one HARQ-ACK transmission occasion for retransmission.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for constructing a HARQ-ACK codebook;

FIG. 2 is a schematic block diagram illustrating one embodiment of an apparatus that may be used for constructing a HARQ-ACK codebook;

FIG. 3 is a schematic block diagram illustrating one embodiment of an apparatus that may be used for constructing a HARQ-ACK codebook;

FIGS. 4A through 4C are diagrams illustrating one embodiment of a physical cell group config IE;

FIG. 5 is a flow chart diagram illustrating one embodiment of a method for constructing a HARQ-ACK codebook; and

FIG. 6 is a flow chart diagram illustrating another embodiment of a method for constructing a HARQ-ACK codebook.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following; an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

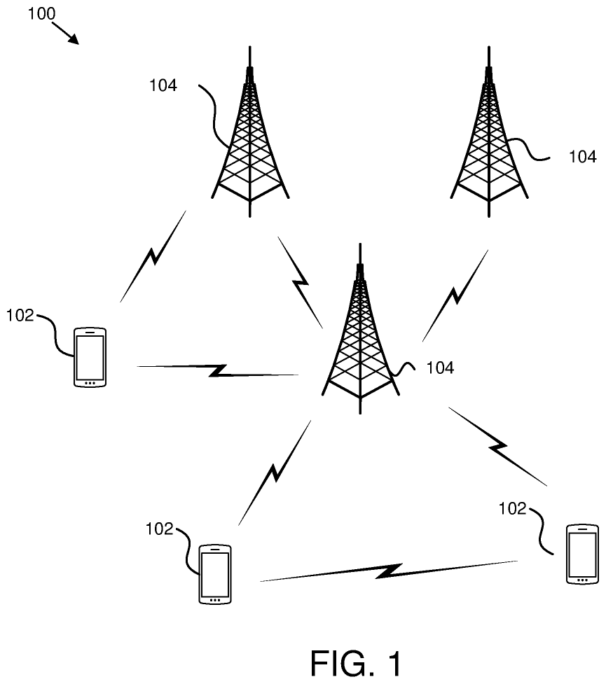

FIG. 1 depicts an embodiment of a wireless communication system 100 for constructing a HARQ-ACK codebook. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may detect a DCI format including DCI indicating HARQ-ACK retransmission. The DCI indicating HARQ-ACK retransmission includes an indication of at least one HARQ-ACK transmission occasion for retransmission. In some embodiments, the remote unit 102 may construct a HARQ-ACK codebook based on the indication of the at least one HARQ-ACK transmission occasion for retransmission. In certain embodiments, the remote unit 102 may transmit the HARQ-ACK codebook in a first slot. Accordingly, the remote unit 102 may be used for constructing a HARQ-ACK codebook.

In certain embodiments, a network unit 104 may transmit a DCI format including DCI indicating HARQ-ACK retransmission. The DCI indicating HARQ-ACK retransmission includes an indication of at least one HARQ-ACK transmission occasion for retransmission. In some embodiments, network unit 104 may receive a HARQ-ACK codebook in a first slot. The HARQ-ACK codebook is constructed based on the indication of the at least one HARQ-ACK transmission occasion for retransmission. Accordingly, the network unit 104 may be used for constructing a HARQ-ACK codebook.

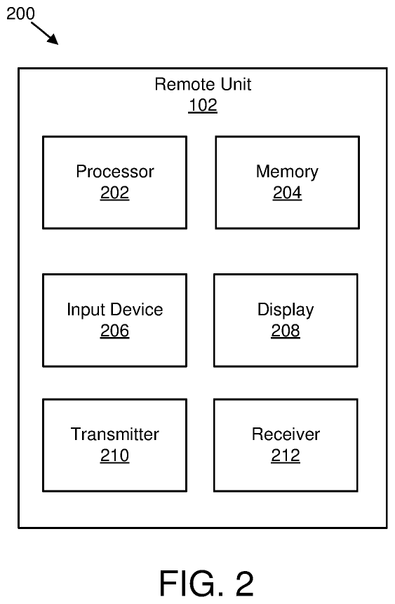

FIG. 2 depicts one embodiment of an apparatus 200 that may be used for constructing a HARQ-ACK codebook. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202 to: detect a DCI format including DCI indicating HARQ-ACK retransmission, wherein the DCI indicating HARQ-ACK retransmission includes an indication of at least one HARQ-ACK transmission occasion for retransmission; and construct a HARQ-ACK codebook based on the indication of the at least one HARQ-ACK transmission occasion for retransmission. In various embodiments, the transmitter 210 to transmit the HARQ-ACK codebook in a first slot.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

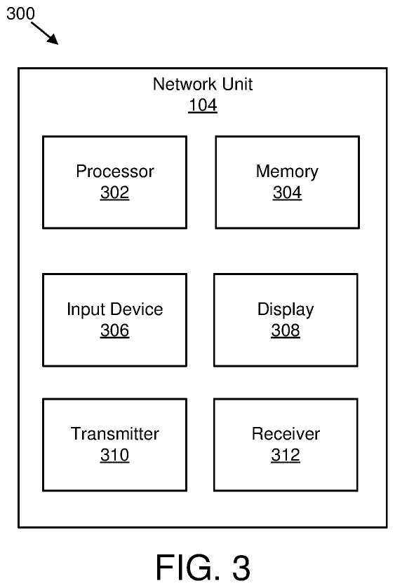

FIG. 3 depicts one embodiment of an apparatus 300 that may be used for constructing a HARQ-ACK codebook. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310 to transmit a DCI format including DCI indicating HARQ-ACK retransmission. The DCI indicating HARQ-ACK retransmission includes an indication of at least one HARQ-ACK transmission occasion for retransmission. In some embodiments, the receiver 312 to receive a HARQ-ACK codebook in a first slot. The HARQ-ACK codebook is constructed based on the indication of the at least one HARQ-ACK transmission occasion for retransmission.

It should be noted that one or more embodiments described herein may be combined into a single embodiment.

In certain embodiments, such as in 3GPP new radio (“NR”), a user equipment (“UE”) may be configured to generate two hybrid automatic repeat request (“HARQ”) acknowledgement (“ACK”) (“HARQ-ACK”) codebooks, one associated with a high priority physical uplink control channel (“PUCCH”) and the other associated with a low priority PUCCH. In such embodiments, if the UE would transmit a PUCCH or physical uplink shared channel (“PUSCH”) of a higher priority index that fully or partially overlaps (e.g., in a time domain) with transmission of a PUCCH or PUSCH of a lower priority index, the UE cancels the transmission of the PUCCH or PUSCH of the lower priority index and accordingly cancels corresponding HARQ-ACK feedback. Further, the UE may have to cancel HARQ-ACK transmission due to unavailable PUCCH or PUSCH resources (e.g., overlapping with a synchronization signal block (“SSB”), control resource set (“CORESET”), or other downlink (“DL”) symbols) and/or reception of an uplink cancellation indication.

In some embodiments, HARQ-ACK re-transmission may: 1) support a Type 3 HARQ-ACK codebook (“CB”) with smaller size (e.g., definition of enhanced Type 3 CB; a) the codebook size of a single triggered enhanced Type 3 HARQ-ACK codebook at least determined by radio resource control (“RRC”) configuration; b) the codebook construction uses HARQ processes (e.g., ordered according to HARQ identifiers (“IDs”) (“HARQ-IDs”) and serving cells)); and/or 2) support one-shot triggering (e.g., by a DL assignment) of HARQ-ACK re-transmission on a PUCCH resource other than enhanced Type 2 or (e.g., enhanced) Type 3 HARQ-ACK CB.

In an implementation, enhanced Type 3 HARQ-ACK CB and/or one-shot triggering (e.g., by a DL assignment) of HARQ-ACK re-transmission on a PUCCH resource other than enhanced Type 2 or (e.g., enhanced) Type 3 HARQ-ACK CB are subject to separate UE capabilities.

As described herein, there may be methods to support flexible retransmission of HARQ-ACK feedback.

In various embodiments there is a downlink control information (“DCI”) Format 1_1. In such embodiments, DCI format 1_1 is used for the scheduling of physical downlink shared channel (“PDSCH”) in one cell. Moreover, the following information is transmitted by means of the DCI format 1_1 with a cyclic redundancy cycle (“CRC”) scrambled by a cell (“C”) radio network temporary identifier (“RNTI”) (“C-RNTI”), a configured scheduling (“CS”) RNTI (“CS-RNTI”), or a modulation and coding scheme (“MCS”) C-RNTI (“MCS-C-RNTI”): 1) downlink assignment index—number of bits as defined in the following; a) 6 bits if more than one serving cell are configured in the DL and the higher layer parameter nfi-TotalDAI-Included=true=enable—the 4 MSB bits are the counter DAI and the total DAI for the scheduled PDSCH group, and the 2 least significant bit (“LSB”) bits are the total DAI for the non-scheduled PDSCH group, b) 4 bits if only one serving cell are configured in the DL and the higher layer parameter nfi-TotalDAI-Included=true=enable—the 2 most significant bit (“MSB”) bits are the counter DAI for the scheduled PDSCH group, and the 2 LSB bits are the total DAI for the non-scheduled PDSCH group, c) 4 bits if more than one serving cell are configured in the DL, the higher layer parameter pdsch-HARQ-ACK-Codebook=dynamic or pdsch-HARQ-ACK-Codebook-r16=enhancedDynamic, and nfi-TotalDAI-Included=true is not configured, where the 2 MSB bits are the counter DAI and the 2 LSB bits are the total DAI, d) 4 bits if one serving cell is configured in the DL, and the higher layer parameter pdsch-HARQ-ACK-Codebook=dynamic, and the UE is not provided coresetPoolIndex or is provided coresetPoolIndex with value 0 for one or more first CORESETs and is provided coresetPoolIndex with value I for one or more second CORESETs, and is provided ackNackFeedbackMode=joint, where the 2 MSB bits are the counter DAI and the 2 LSB bits are the total DAI, c) 2 bits if only one serving cell is configured in the DL, the higher layer parameter pdsch-HARQ-ACK-Codebook=dynamic or pdsch-HARQ-ACK-Codebook-r16=enhancedDynamic, and nfi-TotalDAI-Included=true is not configured, when the UE is not configured with coresetPoolIndex or the value of coresetPoolIndex is the same for all CORESETs if coresetPoolIndex is provided or the UE is not configured with ackNack Feedback Mode=joint, where the 2 bits are the counter DAI, f) 0 bits otherwise, if higher layer parameter priorityIndicatorDCI-1-1 is configured, if the bit width of the Downlink assignment index in DCI format 1_1 for one HARQ-ACK codebook is not equal to that of the Downlink assignment index in DCI format 1_1 for the other HARQ-ACK codebook, a number of most significant bits with value set to ‘0’ are inserted to smaller Downlink assignment index until the bit width of the Downlink assignment index in DCI format 1_1 for the two HARQ-ACK codebooks are the same; 2) transmit power control (“TPC”) command for scheduled PUCCH-2 bits; 3) PUCCH resource indicator—3 bits; 4) PDSCH-to-HARQ_feedback timing indicator-0, 1, 2, or 3 bits—the bitwidth for this field is determined as [log₂(I)] bits, where I is the number of entries in the higher layer parameter dl-DataToUL-ACK—if higher layer parameter priority IndicatorDCI-1-1 is configured, if the bit width of the PDSCH-to-HARQ_feedback timing indicator in DCI format 1_1 for one HARQ-ACK codebook is not equal to that of the PDSCH-to-HARQ_feedback timing indicator in DCI format 1_1 for the other HARQ-ACK codebook, a number of most significant bits with value set to ‘0’ are inserted to smaller PDSCH-to-HARQ_feedback timing indicator until the bit width of the PDSCH-to-HARQ_feedback timing indicator in DCI format 1_1 for the two HARQ-ACK codebooks are the same; 5) one-shot HARQ-ACK request-0 or 1 bit; a) 1 bit if higher layer parameter pdsch-HARQ-ACK-OneShotFeedback-r16 is configured, b) 0 bit otherwise; 6) PDSCH group index-0 or 1 bit; a) 1 bit if the higher layer parameter pdsch-HARQ-ACK-Codebook-r16=enhancedDynamic, b) 0 bit otherwise; 7) new feedback indicator—0, 1 or 2 bits; a) 1 bit if the higher layer parameter pdsch-HARQ-ACK-Codebook-r16=enhancedDynamic and the higher layer parameter nfi-TotalDAI-Included is not configured, b) 2 bits if the higher layer parameter pdsch-HARQ-ACK-Codebook-r16=enhancedDynamic and the higher layer parameter nfi-TotalDAI-Included=true, the MSB corresponds to the scheduled PDSCH group, and the LSB corresponds to the non-scheduled PDSCH group, c) 0 bit otherwise; and 8) number of requested PDSCH groups—0 or 1 bit; a) 1 bit if the higher layer parameter pdsch-HARQ-ACK-Codebook-r16=enhancedDynamic, b) 0 bit otherwise.

In some embodiments, there may be HARQ-ACK codebook determination. If a UE is provided pdsch-HARQ-ACK-CodebookList, the UE can be indicated by pdsch-HARQ-ACK-Codebook List to generate one or two HARQ-ACK codebooks. If the UE is indicated to generate one HARQ-ACK codebook, the HARQ-ACK codebook is associated with a PUCCH of priority index 0. If a UE is provided pdsch-HARQ-ACK-CodebookList, the UE multiplexes in a same HARQ-ACK codebook only HARQ-ACK information associated with a same priority index. If the UE is indicated to generate two HARQ-ACK codebooks: 1) a first HARQ-ACK codebook is associated with a PUCCH of priority index 0 and a second HARQ-ACK codebook is associated with a PUCCH of priority index 1; and 2) the UE is provided first and second for each of {PUCCH-Config, UCI-OnPUSCH, PDSCH-codeBlockGroup Transmission} by {PUCCH-ConfigurationList, UCI-OnPUSCH-ListDCI-0-1, PDSCH-CodeBlockGroupTransmission List} or {PUCCH-ConfigurationList, UCI-OnPUSCH-ListDCI-0-2, PDSCH-CodeBlockGroupTransmissionList}, respectively, for use with the first and second HARQ-ACK codebooks, respectively.

If a UE receives a PDSCH without receiving a corresponding physical downlink control channel (“PDCCH”), or if the UE receives a PDCCH indicating a SPS PDSCH release, the UE generates one corresponding HARQ-ACK information bit. If the UE generates two HARQ-ACK codebooks, the UE is indicated by harq-CodebookID, per SPS PDSCH configuration, a HARQ-ACK codebook index for multiplexing the corresponding HARQ-ACK information bit.

If a UE is provided pdsch-HARQ-ACK-OneShotFeedback and the UE detects a DCI format in any PDCCH monitoring occasion that includes a One-shot HARQ-ACK request field with value 1; 1) the UE includes the HARQ-ACK information in a Type-3 HARQ-ACK codebook; and 2) the UE does not expect that the PDSCH-to-HARQ_feedback timing indicator field of the DCI format provides an inapplicable value from dl-DataToUL-ACK-r16.

In various embodiments, reference is to one HARQ-ACK codebook and to DCI formats that schedule PDSCH reception, or indicate SPS PDSCH release, or indicate SCell dormancy without scheduling a PDSCH reception and are associated with the HARQ-ACK codebook.

If a UE is configured to receive SPS PDSCHs in a slot for SPS configurations that are indicated to be released by a DCI format, and if the UE receives the PDCCH providing the DCI format in the slot where the end of a last symbol of the PDCCH reception is not after the end of a last symbol of any of the SPS PDSCH receptions, and if HARQ-ACK information for the SPS PDSCH release and the SPS PDSCH receptions would be multiplexed in a same PUCCH, the UE does not expect to receive the SPS PDSCHs, does not generate HARQ-ACK information for the SPS PDSCH receptions, and generates a HARQ-ACK information bit for the SPS PDSCH release.

If a UE detects a DCI format 1_1 indicating: 1) secondary cell (“SCell”) dormancy without scheduling a PDSCH reception; and 2) is provided pdsch-HARQ-ACK-Codebook=dynamic or pdsch-HARQ-ACK-Codebook-r16, then the UE generates a HARQ-ACK information bit for a DCI format 1_1 indicating SCell dormancy and the HARQ-ACK information bit value is ACK.

If a UE is not provided PDSCH-CodeBlockGroup Transmission, the UE generates one HARQ-ACK information bit per transport block. For a HARQ-ACK information bit, a UE generates a positive acknowledgement (ACK) if the UE detects a DCI format that provides a SPS PDSCH release or correctly decodes a transport block, and generates a negative acknowledgement (NACK) if the UE does not correctly decode the transport block. A HARQ-ACK information bit value of 0 represents a NACK while a HARQ-ACK information bit value of 1 represents an ACK. In certain embodiments, the CRC for a DCI format is scrambled with a C-RNTI, an MCS-C-RNTI, or a CS-RNTI.

In some embodiments, there may be a Type-2 HARQ-ACK codebook determination. This may apply if the UE is configured with pdsch-HARQ-ACK-Codebook=dynamic or with pdsch-HARQ-ACK-Codebook-r16. Unless stated otherwise, a PDSCH-to-HARQ_feedback timing indicator field provides an applicable value.

In various embodiments, a UE does not expect to multiplex in a Type-2 HARQ-ACK codebook HARQ-ACK information that is in response to a detection of a DCI format that does not include a counter DAI field.

If a UE receives a first DCI format that the UE detects in a first PDCCH monitoring occasion and includes a PDSCH-to-HARQ_feedback timing indicator field providing an inapplicable value from dl-DataToUL-ACK-r16; 1) if the UE detects a second DCI format, the UE multiplexes the corresponding HARQ-ACK information in a PUCCH or PUSCH transmission in a slot that is indicated by a value of a PDSCH-to-HARQ_feedback timing indicator field in the second DCI format, where; a) if the UE is not provided pdsch-HARQ-ACK-Codebook-r16, the UE detects the second DCI format in any PDCCH monitoring occasion after the first one, and where the slot indicated by the value of the PDSCH-to-HARQ_feedback timing indicator field in the second DCI format is no later than a slot for HARQ-ACK information in response to a SPS PDSCH reception, if any, received after the PDSCH scheduled by the first DCI format, b) if the UE is provided pdsch-HARQ-ACK-Codebook-r16, the UE detects the second DCI format in any PDCCH monitoring occasion after the first one, and the second DCI format indicates a HARQ-ACK information report for a same PDSCH group index as indicated by the first DCI format. and where the slot indicated by the value of the PDSCH-to-HARQ_feedback timing indicator field in the second DCI format is no later than a slot for HARQ-ACK information in response to a SPS PDSCH reception, if any, received after the PDSCH scheduled by the first DCI format. c) if the UE is provided pdsch-HARQ-ACK-Codebook=enhancedDynamic-r16. the UE receives the second DCI format later than the slot for HARQ-ACK information in response to a SPS PDSCH reception received after the PDSCH scheduled by the first DCI format, and the second DCI format indicates a HARQ-ACK information report for a same PDSCH group index as indicated by the first DCI format. d) if the UE is provided pdsch-HARQ-ACK-OneShotFeedback. the first DCI format does not indicate SPS PDSCH release or SCell dormancy. the UE detects the second DCI format in any PDCCH monitoring occasion after the first one, and the second DCI format includes a One-shot HARQ-ACK request field with value 1. the UE includes the HARQ-ACK information in a Type-3 HARQ-ACK codebook, and where the slot indicated by the value of the PDSCH-to-HARQ_feedback timing indicator field in the second DCI format is no later than a slot for HARQ-ACK information in response to a SPS PDSCH reception. if any, received after the PDSCH scheduled by the first DCI format, d) if the UE is provided pdsch-HARQ-ACK-OneShotFeedback-r16. the first DCI format does not indicate SPS PDSCH release or SCell dormancy, and the UE receives the second DCI format later than the slot for HARQ-ACK information in response to a SPS PDSCH reception received after the PDSCH scheduled by the first DCI format, and the second DCI format includes a One-shot HARQ-ACK request field with value 1. the UE includes the HARQ-ACK information in a Type-3 HARQ-ACK codebook; and 2) otherwise. the UE docs not multiplex the corresponding HARQ-ACK information in a PUCCH or PUSCH transmission.

In certain embodiments. there may be a Type-2 HARQ-ACK codebook in physical uplink control channel. In such embodiments. a UE determines monitoring occasions for PDCCH with DCI format scheduling PDSCH receptions or SPS PDSCH release or indicating SCell dormancy on an active DL bandwidth part (“BWP”) of a serving cell c. and for which the UE transmits HARQ-ACK information in a same PUCCH in slot n based on: 1) PDSCH-to-HARQ_feedback timing indicator field values for PUCCH transmission with HARQ-ACK information in slot n in response to PDSCH receptions, SPS PDSCH release or SCell dormancy indication; and 2) slot offsets K₀ provided by time domain resource assignment field in a DCI format scheduling PDSCH receptions and by pdsch-AggregationFactor, or pdsch-AggregationFactor-r16, or repetitionNumber, when provided.

The set of PDCCH monitoring occasions for a DCI format scheduling PDSCH receptions or semi-persistent scheduling (“SPS”) PDSCH release or indicating SCell dormancy is defined as the union of PDCCH monitoring occasions across active DL BWPs of configured serving cells. PDCCH monitoring occasions are indexed in an ascending order of their start times. The cardinality of the set of PDCCH monitoring occasions defines a total number M of PDCCH monitoring occasions.

A value of the counter downlink assignment indicator (“DAI”) field in DCI formats denotes the accumulative number of {serving cell, PDCCH monitoring occasion }-pair(s) in which PDSCH reception(s), SPS PDSCH release or SCell dormancy indication associated with the DCI formats is present up to the current serving cell and current PDCCH monitoring occasion: 1) first, if the UE indicates by type2-HARQ-ACK-Codebook support for more than one PDSCH reception on a serving cell that are scheduled from a same PDCCH monitoring occasion, in increasing order of the PDSCH reception starting time for the same {serving cell, PDCCH monitoring occasion} pair; b) second in ascending order of serving cell index; and 3) third in ascending order of PDCCH monitoring occasion index m, where 0≤m<M.

If, for an active DL BWP of a serving cell, the UE is not provided coresetPoolIndex or is provided coresetPoolIndex with value 0 for one or more first CORESETs and is provided coresetPoolIndex with value 1 for one or more second CORESETs, and is provided ack Nack Feedback Mode=joint, the value of the counter DAI is in the order of the first CORESETs and then the second CORESETs for a same serving cell index and a same PDCCH monitoring occasion index.

The value of the total DAI, when present, in a DCI format denotes the total number of {serving cell, PDCCH monitoring occasion}-pair(s) in which PDSCH reception(s), SPS PDSCH release or SCell dormancy indication associated with DCI formats is present, up to the current PDCCH monitoring occasion m and is updated from PDCCH monitoring occasion to PDCCH monitoring occasion. If, for an active DL BWP of a serving cell, the UE is not provided coresetPoolIndex or is provided coresetPoolIndex with value 0 for one or more first CORESETs and is provided coresetPoolIndex with value I for one or more second CORESETs, and is provided ackNack Feedback Mode=joint, the total DAI value counts the {serving cell, PDCCH monitoring occasion}-pair(s) for both the first CORESETs and the second CORESETs.

Denote by N_{C-DAI}^{DL} the number of bits for the counter DAI and set T_{D}=2^{N}^{_{C−DAI}}^{^{DL}}. Denote by V_{C-DAI,c,m}^{DL} the value of the counter DAI in a DCI format scheduling PDSCH reception, SPS PDSCH release or SCell dormancy indication on serving cell c in PDCCH monitoring occasion m. Denote by V_{T-DAI,m}^{DL} the value of the total DAI in a DCI format in PDCCH monitoring occasion m. The UE assumes a same value of total DAI in all DCI formats that include a total DAI field in PDCCH monitoring occasion m. A UE does not expect to multiplex, in a same Type-2 HARQ-ACK codebook, HARQ-ACK information that is in response to detection of DCI formats with different number of bits for the counter DAI field.

If the UE transmits HARQ-ACK information in a PUCCH in slot n and for any PUCCH format, the UE determines the õ₀^{ACK}, õ₁^{ACK}, . . . , õ_{O}_{_{ACK}}₋₁^{ACK}, for a total number of O_{ACK} HARQ-ACK information bits.

If a UE is configured to receive SPS PDSCH and the UE multiplexes HARQ-ACK information for one activated SPS PDSCH reception in the PUCCH in slot n, the UE generates one HARQ-ACK information bit associated with the SPS PDSCH reception and appends it to the O^{ACK} HARQ-ACK information bits.

If a UE is configured to receive SPS PDSCH and the UE multiplexes HARQ-ACK information for multiple activated SPS PDSCH receptions in the PUCCH in slot n, the UE generates the HARQ-ACK information and appends it to the O^{ACK} HARQ-ACK information bits.

For a PDCCH monitoring occasion with DCI format scheduling PDSCH reception or SPS PDSCH release or indicating SCell dormancy in the active DL BWP of a serving cell, when a UE receives a PDSCH with one transport block or a SPS PDSCH release or indicating SCell dormancy and the value of maxNrofCodeWordsScheduledByDCI is 2, the HARQ-ACK information is associated with the first transport block and the UE generates a NACK for the second transport block if harq-ACK-SpatialBundlingPUCCH is not provided and generates HARQ-ACK information with value of ACK for the second transport block if harq-ACK-SpatialBundlingPUCCH is provided.

If a UE is not provided PDSCH-CodeBlockGroupTransmission for each of the N_{cells}^{DL} serving cells, or for PDSCH receptions scheduled by a DCI format that does not support codeblock group (“CBG”)-based PDSCH receptions, or for SPS PDSCH reception, or for SPS PDSCH release, or for SCell dormancy indication, and if O_{ACK}+O_{SR}+O_{CSI}≤11, the UE determines a number of HARQ-ACK information bits n_{HARQ-ACK} for obtaining a transmission power for a PUCCH, as

$${n}_{HARQ - ACK} = {n}_{HARQ - ACK , TB} = ( ( {V}_{DAI , {m}_{last}}^{DL} - {\sum }_{c = 0}^{{N}_{cells}^{DL} - 1} {U}_{DAI , c} ) mod ( {T}_{D} ) ) {N}_{TB , max}^{DL} + {\sum }_{c = 0}^{{N}_{cells}^{DL} - 1} ( {\sum }_{m = 0}^{M - 1} {N}_{m , c}^{received} + {N}_{SPS , c} ) ,$$

$$where : 1 ) if {N}_{cells}^{DL} = 1 ,$$

V_{DAI,m}_{ₗₐₛₜ}^{DL} is the value of the counter DAI in the last DCI format scheduling PDSCH reception or indicating SPS PDSCH release or indicating SCell dormancy, for any serving cell c that the UE detects within the M PDCCH monitoring occasions; 2) if N_{cells}^{DL}>1; a) if the UE does not detect any DCI format that includes a total DAI field in a last PDCCH monitoring occasion within the M PDCCH monitoring occasions where the UE detects at least one DCI format scheduling PDSCH reception, indicating SPS PDSCH release or indicating SCell dormancy for any serving cell c, V_{DAI,m}_{ₗₐₛₜ}^{DL} is the value of the counter DAI in a last DCI format the UE detects in the last PDCCH monitoring occasion; b) if the UE detects at least one DCI format that includes a total DAI field in a last PDCCH monitoring occasion within the M PDCCH monitoring occasions where the UE detects at least one DCI format scheduling PDSCH reception, indicating SPS PDSCH release or indicating SCell dormancy for any serving cell c, V_{VDAI,m}_{ₗₐₛₜ}^{DL} is the value of the total DAI in the at least one DCI format that includes a total DAI field; 3) V_{DAI,m}_{ₗₐₛₜ}^{DL}=0 if the UE does not detect any DCI format scheduling PDSCH reception, indicating SPS PDSCH release or indicating SCell dormancy for any serving cell c in any of the M PDCCH monitoring occasions; 4) U_{DAI,c} is the total number of a DCI format scheduling PDSCH reception, indicating SPS PDSCH release or indicating SCell dormancy that the UE detects within the M PDCCH monitoring occasions for serving cell c−U_{DAI,c}=0 if the UE does not detect any DCI format scheduling PDSCH reception, indicating SPS PDSCH release or indicating SCell dormancy for serving cell c in any of the M PDCCH monitoring occasions; 5) V_{TB,max}^{DL}=2 if the value of maxNrofCodeWordsScheduledByDCI is 2 for any serving cell c and harq-ACK-SpatialBundlingPUCCH is not provided; otherwise, N_{TB,max}^{DL}=1; 6) N_{m,c}^{received} is the number of transport blocks the UE receives in a PDSCH scheduled by a DCI format that the UE detects in PDCCH monitoring occasion m for serving cell c if harq-ACK-SpatialBundlingPUCCH is not provided, or the number of PDSCH scheduled by a DCI format that the UE detects in PDCCH monitoring occasion m for serving cell c if harq-ACK-SpatialBundlingPUCCH is provided, or the number of DCI format that the UE detects and indicate SPS PDSCH release in PDCCH monitoring occasion m for serving cell c, or the number of DCI format that the UE detects and indicate SCell dormancy in PDCCH monitoring occasion m for serving cell c; and 7) N_{SPS,c} is the number of SPS PDSCH receptions by the UE on serving cell c for which the UE transmits corresponding HARQ-ACK information in the same PUCCH as for HARQ-ACK information corresponding to PDSCH receptions within the M PDCCH monitoring occasions.

If a UE: 1) is provided PDSCH-CodeBlockGroup Transmission for N_{cells}^{DL,CBG} serving cells; and 2) is not provided PDSCH-CodeBlockGroupTransmission, for N_{cells}^{DL,TB} serving cells where N_{cells}^{DL,TB}+N_{cells}^{DL,CBG}=N_{cells}^{DL}, then the UE determines the õ₀^{ACK}, õ₁^{ACK}, . . . , õ_{O}_{_{ACK}}₋₁^{ACK} according to the previous pseudo-code with the following modifications: 1) N_{cells}^{DL} is used for the determination of a first HARQ-ACK sub-codebook for: a) SPS PDSCH release, b) SPS PDSCH reception, c) DCI format 1_1 indicating SCell dormancy, and d) for TB-based PDSCH receptions on the N_{cells}^{DL,CBG} serving cells and on the N_{cells}^{DL,TB} serving cells; 2) N_{cells}^{DL} is replaced by N_{cells}^{DL,CBG} for the determination of a second HARQ-ACK sub-codebook corresponding to the N_{cells}^{DL,CBG} serving cells for CBG-based PDSCH receptions; 3) if, for an active DL BWP of a serving cell, the UE is not provided coresetPoolIndex or is provided coresetPoolIndex with value 0 for one or more first CORESETs and is provided coresetPoolIndex with value 1 for one or more second CORESETs, and is provided ackNackFeedbackMode=joint, the serving cell is counted as two times where the first time corresponds to the first CORESETs and the second time corresponds to the second CORESETs, and a) instead of generating one HARQ-ACK information bit per transport block for a serving cell from the N_{cells}^{DL,CBG} serving cells, the UE generates N_{HARQ-ACK,max}^{CBG/TB,max} HARQ-ACK information bits, where N_{HARQ-ACK,max}^{CBG/TB,max} is the maximum value of N_{TB,c}^{DL}·N_{HARK-ACK,c}^{CBG/TB,max} across all N_{cells}^{DL,CBG} serving cells and N_{TBc}^{DL} is the value of maxNrofCodeWordsScheduledByDCI for serving cell c. If for a serving cell c it is N_{TB,c}^{DL}·N_{HARQ-ACK,c}^{CBG/TB,max}<N_{HARQ-ACK,max}^{CBG/TB,max}, the UE generates NACK for the last N_{HARQ-ACK,max}^{CBG/TB,max}−N_{TB,c}^{DL}·N_{HARQ-ACK,c}^{CBG/TB,max} HARQ-ACK information bits for serving cell c, and b) the pseudo-code operation when harq-ACK-SpatialBundlingPUCCH is provided is not applicable; 3) the counter DAI value and the total DAI value apply separately for each HARQ-ACK sub-codebook; and 4) the UE generates the HARQ-ACK codebook by appending the second HARQ-ACK sub-codebook to the first HARQ-ACK sub-codebook.

If O_{ACK}+O_{SR}+O_{CSI}≤11, the UE also determines n_{HARQ-ACK}=n_{HARQ-ACK,TB}+n_{HARQ-ACK,CBG} for obtaining a PUCCH transmission power, with

$${n}_{HARQ - ACK , CBG} = ( ( {V}_{DAI , {m}_{last}}^{DL} - {\sum }_{c = 0}^{{N}_{cells}^{DL , CBG} - 1} {U}_{DAI , c}^{CBG} ) mod ( {T}_{D} ) ) {N}_{HARQ - ACK , max}^{CBG / DL} + {\sum }_{c = 0}^{{N}_{cells}^{DL} - 1} {\sum }_{m = 0}^{M - 1} {N}_{m , c}^{received , CBG} ,$$

$$where : 1 ) if {N}_{cells}^{DL} = 1 , {V}_{DAI , {m}_{last}}^{DL}$$

is the value of the counter DAI in the last DCI format scheduling CBG-based PDSCH reception for any serving cell c that the UE detects within the M PDCCH monitoring occasions; 2) if N_{cells}^{DL}>1, V_{DAI,m}_{ₗₐₛₜ}^{DL} is the value of the total DAI in the last DCI format scheduling CBG-based PDSCH reception for any serving cell c that the UE detects within the M PDCCH monitoring occasions; 3) V_{DAI,m}_{ₗₐₛₜ}^{DL}=1, if the UE does not detect any DCI format scheduling CBG-based PDSCH reception for any serving cell c in any of the M PDCCH monitoring occasions; 4) U_{DAL,c}^{CBG} is the total number of DCI formats scheduling CBG-based PDSCH receptions that the UE detects within the M PDCCH monitoring occasions for serving cell c. U_{DAI,c}^{CBG}=0 if the UE does not detect any DCI format scheduling CBG-based PDSCH reception for serving cell c in any of the M PDCCH monitoring occasions; and 5) N_{m,c}^{received,CBG} is the number of CBGs the UE receives in a PDSCH scheduled by a DCI format that supports CBG-based PDSCH reception that the UE detects in PDCCH monitoring occasion m for serving cell c and the UE reports corresponding HARQ-ACK information in the PUCCH. Tables 1 and 2 illustrate embodiments of values that may be used for embodiments described herein.

TABLE 1
Value of Counter DAI for N_{C-DAI}^{DL} = 2 and of Total DAI

| | | Number of {serving cell, PDCCH |
|---|---|---|
| | | monitoring occasion}- pair(s) in |
| | | which PDSCH transmission(s) associated |
| | | with PDCCH or PDCCH indicating SPS |
| | | PDSCH release or DCI format 1_1 |
| DAI | V_{C-DAI}^{DL} | indicating SCell dormancy is present, |
| MSB, LSB | or V_{T-DAI}^{DL} | denoted as Y and Y ≥ 1 |
| 0, 0 | 1 | (Y − 1) mod T_{D} + 1 = 1 |
| 0, 1 | 2 | (Y − 1) mod T_{D} + 1 = 2 |
| 1, 0 | 3 | (Y − 1) mod T_{D} + 1 = 3 |
| 1, 1 | 4 | (Y − 1) mod T_{D} + 1 = 4 |

TABLE 2
Value of counter DAI for N_{C-DAI}^{DL} = 1

| | | Number of {serving cell, PDCCH |
|---|---|---|
| | | monitoring occasion}- pair(s) in |
| | | which PDSCH transmission(s) associated |
| | | with PDCCH or PDCCH indicating SPS |
| | | PDSCH release or DCI format 1_1 |
| | | indicating SCell dormancy is present, |
| DAI | V_{C-DAI}^{DL} | denoted as Y and Y ≥ 1 |
| 0 | 1 | (Y − 1) mod T_{D} + 1 = 1 |
| 1 | 2 | (Y − 1) mod T_{D} + 1 = 2 |

In various embodiments, there may be a Type-2 HARQ-ACK codebook grouping and HARQ-ACK retransmission. If a UE is provided pdsch-HARQ-ACK-Codebook, the UE determines HARQ-ACK information for multiplexing in a PUCCH transmission occasion according to the following procedure. Set g to the value of a PDSCH group index field in a last DCI format that provides a value of g and indicates a PUCCH transmission occasion. Set i(g) to denote a PUCCH transmission occasion for multiplexing HARQ-ACK information. Set k to the value of a PDSCH-to-HARQ_feedback timing field, if any, in a DCI format providing a value of g. If the DCI format does not include a PDSCH-to-HARQ_feedback timing field, set k to the value provided by dl-DataToUL-ACK. Set h(g) to the value of a first new feedback indicator field in the last DCI format providing the value of g. Set h^{(g+1)mod2}(g) to a value of a second new feedback indicator field in the last DCI format providing the value of g. Set V_{DAI}^{(g+1)mod2} to the value of a total DAI field for group (g+1)mod2 in the last DCI format providing the value of g.

If g=1 and the UE detects a DCI format that does not include a PDSCH group index field in a PDCCH reception that is after the PDCCH reception for the last DCI format detection providing the value of g and indicating a same slot for a PUCCH transmission occasion, set V_{DAI}^{(g+1)mod2}=Ø. Set q to the value of a number of requested PDSCH group(s) field in the last set VDAI DCI format providing the value of g.

A UE does not expect to detect DCI formats with respective: 1) number of requested PDSCH groups field values of 0; 2) PDSCH-to-HARQ_feedback timing field values that indicate a same PUCCH transmission occasion; and 3) PDSCH group index field values that are different.

In certain embodiments, a system may generate first HARQ-ACK information for PUCCH transmission occasion i(g) in a slot, where: 1) the first HARQ-ACK information corresponds only to detections of DCI formats each providing a same value of g, of h(g), and to detections of DCI formats that do not provide a value of g and h(g) and are associated with a same value of g, of h(g), and at least one of the DCI formats providing a value of k indicating the slot; 2) at least one of the DCI formats provides a h(g) value; and 3) m=0 corresponds to a PDCCH monitoring occasion, where the UE detects a DCI format that provides a value of g or is associated with a value of g, that is the first PDCCH monitoring occasion after a PDCCH monitoring occasion where the UE detects another DCI format that provides a value different than h(g).

The generation of the first HARQ-ACK information for PUCCH transmission occasion i(g) in a slot, excludes the generation of HARQ-ACK information for SPS PDSCH receptions.

If h^{(g+1)mod2}(g)=Ø or h^{(g+1)mod2}(g)=h((g+1)mod2), generate second HARQ-ACK information for PUCCH transmission occasion i((g+1)mod2) in a slot, where: 1) the second HARQ-ACK information corresponds to detections of DCI formats each providing a same value of (g+1)mod2, of h((g+1)mod2) and to detections of DCI formats that do not provide a value of (g+1)mod2, of h((g+1)mod2), but are associated with a same value of (g+1)mod2, of h((g+1)mod2); 2) at least one of the DCI formats provides a h((g+1)mod2) value; 3) m=0 corresponds to a PDCCH monitoring occasion, where the UE detects a DCI format that provides a value of (g+1)mod2 or that is associated with a value of (g+1)mod2, that is the first PDCCH monitoring occasion after a PDCCH monitoring occasion where the UE detects another DCI format that provides a value different than h((g+1)mod2); 4) the PUCCH transmission occasion i((g+1)mod2) is a last one for multiplexing second HARQ-ACK information and it is not after PUCCH transmission occasion i(g); and 5) if V_{DAI}^{(g+1)mod2}≠Ø, after the completion of the c and m loops for the pseudo-code for the second HARQ-ACK codebook generation in Clause 9.1.3.1, set Vₜₑₘₚ₂=V_{DAI}^{(g+1)mod2}. If the UE is provided PDSCH-CodeBlockGroup Transmission for N_{cells}^{DL,CBG} serving cells, set Vₜₑₘₚ₂=V_{DAI}^{(g+1)mod2} for both sub-codebooks before appending the second sub-codebook to the first sub-codebook.

If h^{(g+1)mod2}(g)≠Ø and h^{(g+1)mod2}(g)≠h((g+1)mod2), generate second HARQ-ACK information by setting M=0 and, after the completion of the c and m loops for the pseudo-code for the second HARQ-ACK codebook generation in Clause 9.1.3.1, setting Vₜₑₘₚ₂=V_{DAI}^{(g+1)mod2}.

The generation of the second HARQ-ACK information for PUCCH transmission occasion i((g+1)mod2) in a slot, excludes the generation of HARQ-ACK information for SPS PDSCH receptions.

If q=0, the UE includes only the first HARQ-ACK information for multiplexing in PUCCH transmission occasion i(g), elseif q=1, if g=1, appends the first HARQ-ACK information to the second HARQ-ACK information for multiplexing in PUCCH transmission occasion i(g), else, append the second HARQ-ACK information to the first HARQ-ACK information for multiplexing in PUCCH transmission occasion i(g), end if, end if.

The UE appends the HARQ-ACK information corresponding to SPS PDSCH receptions, if any, after the first and second, if any, HARQ-ACK information.

If the HARQ-ACK information is multiplexed in a PUSCH transmission, the HARQ-ACK information is determined as: 1) for multiplexing in PUCCH transmission occasion i(g), if the PUSCH transmission is not scheduled by a DCI format or is scheduled by a DCI format that does not include a DCI field with value V_{DAI}^{UL}; 2) for multiplexing in PUCCH transmission occasion i(g), if the PUSCH transmission is scheduled by a DCI format without ul-TotalDAI-Included configured except that for PDSCH group g, the DCI field with value V_{DAI}^{UL} in the DCI format is used after the completion of the c and m loops for the pseudo-code for the HARQ-ACK codebook generation, and when the HARQ-ACK information multiplexed in the PUCCH transmission occasion i(g) does not include HARQ-ACK information for PDSCH group (g+1)mod2; 3) for multiplexing in PUCCH transmission occasion i(g), if the PUSCH transmission is scheduled by a DCI format without ul-TotalDAI-Included configured except that for PDSCH group g=0, the DCI field with value Vyh DAI in the DCI format is used after the completion of the c and m loops for the pseudo-code for the HARQ-ACK codebook generation, and when the HARQ-ACK information multiplexed in the PUCCH transmission occasion i(g) includes HARQ-ACK information for PDSCH groups g and (g+1)mod2; 4) for multiplexing in PUCCH transmission occasion i(g), if the PUSCH transmission is scheduled by a DCI format without ul-TotalDAI-Included configured except that for PDSCH group g=0, the DCI field with value V_{DAI}^{UL} in the DCI format is used after the completion of the c and m loops for the pseudo-code for the HARQ-ACK codebook generation, and when the UE has not detected any DCI format scheduling PDSCH receptions, and the UE has not detected any DCI format with a request for HARQ-ACK information for any PDSCH group; and 5) for multiplexing in PUCCH transmission occasion i(g), if the PUSCH transmission is scheduled by a DCI format with ul-TotalDAI-Included configured except that MSBs of the DCI field with value V_{DAI}^{UL} in the DCI format are used for PDSCH group g=0, and LSBs of DCI field with value V_{DAI} ^{UL} in the DCI format are used for PDSCH group g=1, after the completion of the c and m loops for the pseudo-code for the HARQ-ACK codebook generation.

If a UE is scheduled a PUSCH transmission by DCI format 0_1 having a DAI field value V_{DAI}^{UL}=4 for a PDSCH group index, and the UE has not detected any DCI format scheduling PDSCH receptions for the PDSCH group index, and the UE has not detected any DCI format with a request for HARQ-ACK information for the PDSCH group index, the UE does not multiplex HARQ-ACK information in the PUSCH transmission for the PDSCH group index.

If a UE detects DCI formats with respective PDSCH-to-HARQ_feedback timing field values indicating a same PUCCH transmission occasion and none of the DCI formats that the UE detects after a last PUCCH transmission occasion for g=0 includes a New feedback indicator field for g=0, and at least one of the DCI formats is DCI format 1_0, the UE generates HARQ-ACK information only for PDSCH receptions scheduled by detections of DCI format 1_0 and SPS PDSCH releases indicated by detections of DCI format 1_0 or for multiplexing in the PUCCH transmission occasion.

If a DCI format indicating a slot for a PUCCH transmission occasion does not include a new feedback indicator field, a PDSCH reception scheduled by the DCI format or a SPS PDSCH release indicated by the DCI format is associated with PDSCH group 0 and a value of h(g) associated with the DCI format is set only if h(g) is provided by another DCI format that provides a value of h(g) for PDSCH group 0 and indicates the slot for the PUCCH transmission occasion.

For PUCCH transmission occasion i(g), the UE determines a PUCCH or a PUSCH transmission to multiplex the HARQ-ACK information.

If O_{ACK}+O_{SR}+O_{CSI}≤11, the UE determines a number of HARQ-ACK information bits n_{HARQ-ACK,g} for group g and a number of HARQ-ACK information bits n_{HARQ-ACK,(g+1)mod2} for group (g+1)mod2 where N_{SPS,c} is included in n_{HARQ-ACK,g} and, if q=1 and V_{DAI}^{(g+1)mod2}≠Ø, the UE determines n_{HARQ-ACK,(g+1)mod2} by setting V_{DAI,m}_{ₗₐₛₜ}^{DL}=V_{DAI}^{(g+1)mod2}. For obtaining a PUCCH transmission power, if q=0, n_{HARQ-ACK}=n_{HARQ-ACK,g}; else, n_{HARQ-ACK}=n_{HARQ-ACK,g}+n_{HARQ-ACK,(g+1)mod2}.

In various embodiments, there may be a UE procedure for reporting HARQ-ACK. With reference to slots for PUCCH transmissions, if the UE detects a DCI format scheduling a PDSCH reception ending in slot n or if the UE detects a DCI format indicating a SPS PDSCH release or indicating SCell dormancy through a PDCCH reception ending in slot n, or if the UE detects a DCI format that requests Type-3 HARQ-ACK codebook report and does not schedule a PDSCH reception through a PDCCH reception ending in slot n, the UE provides corresponding HARQ-ACK information in a PUCCH transmission within slot n+k, where k is a number of slots and is indicated by the PDSCH-to-HARQ_feedback timing indicator field in the DCI format, if present, or provided by dl-DataToUL-ACK, dl-DataToUL-ACK-r16, or dl-DataToUL-ACKForDCIFormat1_2. k=0 corresponds to the last slot of the PUCCH transmission that overlaps with the PDSCH reception or with the PDCCH reception in case of SPS PDSCH release or in case of SCell dormancy indication or in case of the DCI format that requests Type-3 HARQ-ACK codebook report and does not schedule a PDSCH reception.

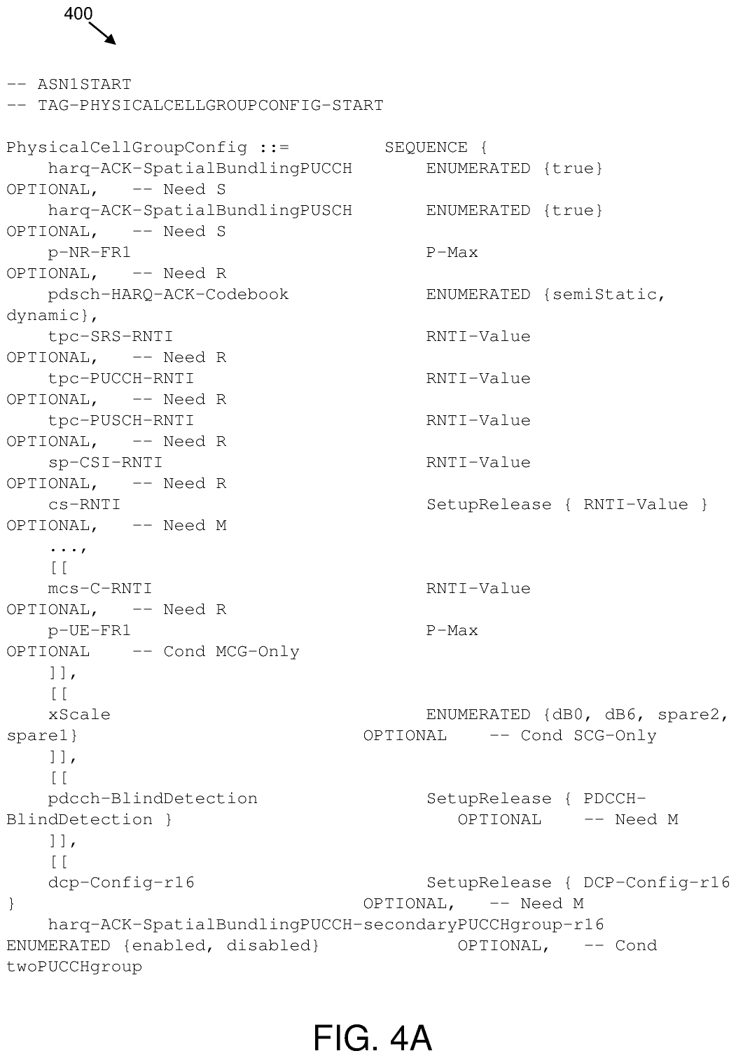

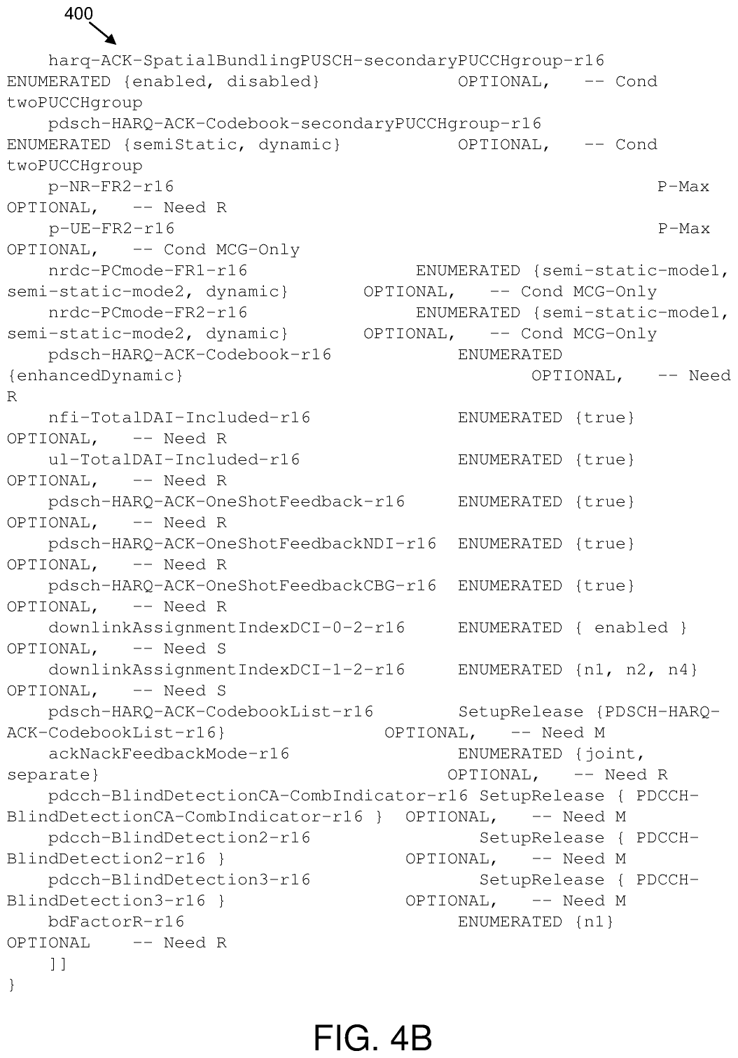

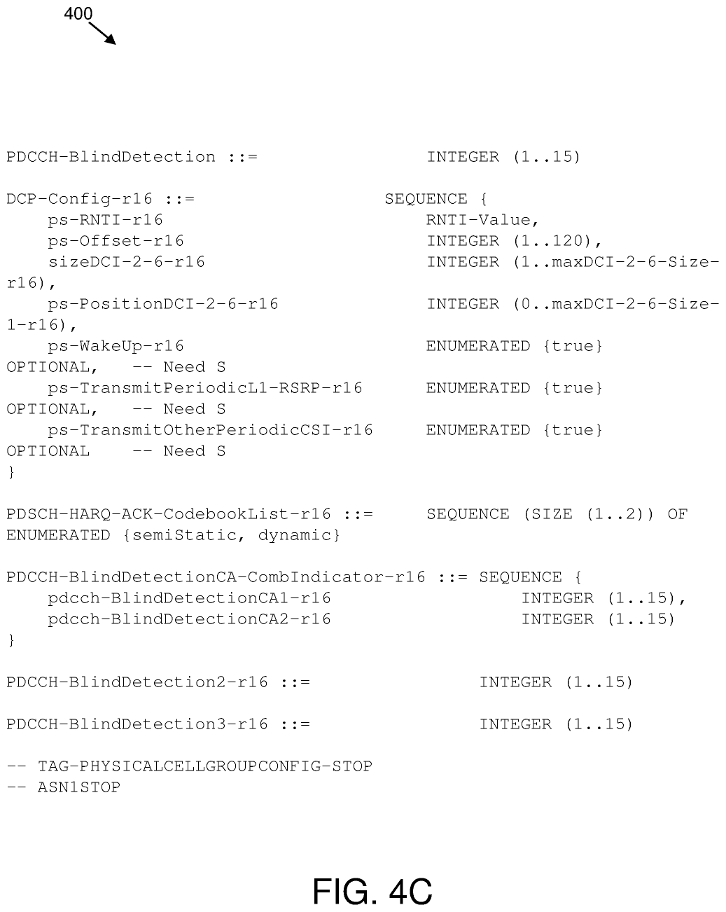

FIGS. 4A through 4C are diagrams illustrating one embodiment of a physical cell group configuration (“config”) information element (“IE”) 400. The physical cell group config IE is used to configure cell-group specific layer 1 (“L1”) parameters.

In certain embodiments, nfi-TotalDAI-Included may indicate whether new feedback indicator (“NFI”) and total DAI fields of the non-scheduled PDSCH group are included in a non-fallback DL grant DCI. The network configures this only if an enhanced dynamic codebook is configured (pdsch-HARQ-ACK-Codebook is set to enhancedDynamic).

In some embodiments, ul-TotalDAI-Included may indicate whether total DAI fields of an additional PDSCH group is included in a non-fallback UL grant DCI. The network configures this only if an enhanced dynamic codebook is configured (pdsch-HARQ-ACK-Codebook is set to enhancedDynamic).

In various embodiments, one or more elements or features from one or more of the described embodiments may be combined.

In certain embodiments, there may be flexible retransmission of HARQ-ACK feedback. In one embodiment, a UE detects a DCI format with DCI including information of HARQ-ACK retransmission, constructs a HARQ-ACK codebook for retransmission based on the information of HARQ-ACK retransmission, and transmits the HARQ-ACK codebook in a PUCCH or a PUSCH. The information of HARQ-ACK retransmission includes information of one or more canceled HARQ-ACK transmission occasions for retransmission (e.g., a number of canceled HARQ-ACK codebooks to be included for retransmission and timing information of the one or more canceled HARQ-ACK transmission occasions (e.g., in terms of slot and/or sub-slot offset with respect to a DL slot where the DCI format triggering retransmission is detected)). This information allows the UE to have a common understanding with a network entity in terms of canceled HARQ-ACK transmission occasions and allows the network entity to avoid confusion due to missed DCI and corresponding missed HARQ-ACK feedback by the UE.

In some embodiments, information of HARQ-ACK retransmission may further include information or an indication of one or more non-canceled HARQ-ACK transmission occasions for retransmission (e.g., HARQ-ACK or HARQ-ACK codebooks associated with the non-canceled HARQ-ACK transmission occasions that may have been received with a low reliability at a receiving (e.g., network) entity). In some examples, a retransmitted HARQ-ACK codebook may further include HARQ-ACK information for one or more non-canceled HARQ-ACK transmissions.

In one implementation, a DCI format triggering HARQ-ACK retransmission is a DL DCI format. Further, the DCI format may include a bit field indicating HARQ-ACK information triggered for retransmission. For example, DCI format 1_1, 1_2, or other DL DCI formats may be configured with the bit field ‘HARQ-ACK retransmission indicator’ as follows; HARQ-ACK retransmission indicator-the bitwidth for this field is determined as [log2(1)] bits, where I is the number of entries in the higher layer harq-ack RetransmissionList if the higher layer parameter is configured; otherwise I is the number of entries in the default table shown in Table 3.

TABLE 3
Default table for the HARQ-ACK retransmission indicator field

| | Slot/sub-slot offset(s) of cancelled | |
|---|---|---|
| | HARQ-ACK transmission occasions | Number of cancelled |
| | with respect to a DL slot where | HARQ-ACK transmis- |
| Row | a DCI format triggering HARQ-ACK | sion occasions for |
| index | retransmission is detected | retransmission |
| 1 | N/A | 0 |
| 2 | 1 slot | 1 |
| 3 | 2 slots | 1 |
| 4 | 4 slots (for 1st occasion) and 2 slots | 2 |
| | (for 2nd occasion) | |

In some examples, the slot and/or sub-slot offset values may be limited to be within a certain time window from the DL slot in which the DCI format triggering HARQ-ACK retransmission is received (e.g., within a frame or half-frame prior to the slot (or sub-slot) in which the DCI is received).

In various embodiments, a UE determines a PUCCH resource based on a PUCCH resource indicator (“PRI”) field in the DL DCI format and may transmit a constructed HARQ-ACK codebook for retransmission in the determined PUCCH resource (e.g., as long as the PUCCH resource does not collide with other UL transmissions). The constructed HARQ-ACK codebook for retransmission includes HARQ-ACK information from the canceled HARQ-ACK transmission occasions for retransmission indicated by the DL DCI format and newly generated HARQ-ACK information from the DL DCI format itself (e.g., HARQ-ACK for a PDSCH scheduled by the DL DCI format or HARQ-ACK for SPS release or SCell dormancy indicated by the DL DCI format).

In another embodiment, a DCI format triggering HARQ-ACK retransmission is an UL DCI format that includes PUSCH scheduling information (e.g., an UL grant). A UE determines a PUSCH resource based on scheduling information and multiplexes a constructed HARQ-ACK codebook for retransmission into the scheduled PUSCH resource.

In one embodiment, a UE constructs a HARQ-ACK codebook for retransmission by concatenating one or more canceled HARQ-ACK codebooks corresponding to one or more canceled HARQ-ACK transmission occasions indicated by a network entity (e.g., via DCI triggering HARQ-ACK retransmission) and additionally a non-canceled HARQ-ACK codebook generated and/or updated by the DCI triggering the HARQ-ACK retransmission. In one example, the canceled HARQ-ACK codebooks are concatenated in an order of start time of canceled HARQ-ACK transmission occasions, and the non-canceled HARQ-ACK codebook is appended in the last (e.g., at the end of the concatenation).

If the UE did not have HARQ-ACK information for a given canceled HARQ-ACK transmission occasion indicated by the network entity due to missed DCI detection or other errors, the UE uses a default (e.g., predefined) HARQ-ACK codebook for the corresponding canceled HARQ-ACK transmission occasion when performing concatenation.

Further, the UE may receive information of a reference HARQ-ACK codebook size per canceled HARQ-ACK transmission occasion to be assumed and/or used when constructing the HARQ-ACK codebook for retransmission to avoid misinterpretation of concatenated HARQ-ACK codebooks at the network entity. If a size of a HARQ-ACK codebook generated for a given canceled HARQ-ACK transmission occasion is smaller than the reference HARQ-ACK codebook size, the UE appends zero bits to the generated HARQ-ACK codebook until the size of the generated HARQ-ACK codebook matches the reference HARQ-ACK codebook size.

In certain embodiments, if a UE transmits a HARQ-ACK codebook for retransmission (e.g., triggered by DCI) and other UCI (e.g., such as scheduling request (“SR”) and channel state information (“CSI”), if any) in a PUCCH using PUCCH format 2, PUCCH format 3, or PUCCH format 4, and if the number of UCI bits is smaller than or equal to 11, the UE determines the number of HARQ-ACK information bits nHARQ-ACK for obtaining a transmission power value for the PUCCH as a size of the HARQ-ACK codebook for retransmission (e.g., including an indicated canceled HARQ-ACK codebook and non-canceled HARQ-ACK information in response to the triggering DCI, if any).

For a PUCCH transmission using PUCCH format 2, PUCCH format 3, or PUCCH format 4, and for a number of UCI bits smaller than or equal to 11, Δ_{TF,b,f,c}(i)=10 log₁₀(K₁·(n_{HARQ-ACK}(i)+O_{SR}(i))/N_{RE}(i)), where K₁=6, −n_{HARQ-ACK}(i) is the same as O_{ACK}(i), where O_{ACK}(i)=O_{ACK,cancelled}·N_{c}+O_{ACK,current}, where O_{ACK,cancelled} indicates a reference number of HARQ-ACK bits for a cancelled HARQ-ACK codebook, N_{c} is a number of cancelled HARQ-ACK codebooks for retransmission, and O_{ACK,current} is a number of HARQ-ACK bits for a non-cancelled HARQ-ACK codebook, O_{SR}(i) is a number of SR information bits, O_{CSI}(i) is a number of CSI information bits, and N_{RE}(i) is a number of resource elements determined as N_{RE}(i)=M_{RBA,f,c}^{PCCH}(i)·N_{sc,ctrl}^{RB}(i)·N_{symb-UCI,b,f,c}^{PUCCH}(i), where N_{sc,ctrl}^{RB}(i) is a number of subcarriers per resource block excluding subcarriers used for demodulation reference signal (“DM-RS”) transmission, and N_{symb-UCIb,f,c}^{PUCCH}(i) is a number of symbols excluding symbols used for DM-RS transmission for PUCCH transmission occasion i on active UL BWP b of carrier f of primary cell c.

In one embodiment, if a UE detects [X] sets of DCI formats in [X] sets of PDCCH monitoring occasions, where each DCI format of the [X] sets of DCI formats includes a PDSCH-to-HARQ_feedback timing indicator field providing an applicable value from dl-DataToUL-ACK-r17, each set of DCI formats of the [X] sets of DCI formats indicates a HARQ-ACK feedback transmission on a same slot/sub-slot, and all of [X] HARQ-ACK feedback transmissions corresponding to the [X] sets of DCI formats are cancelled: 1) if the UE detects a second DCI format in any PDCCH monitoring occasion after the [X] sets of PDCCH monitoring occasions. the UE is configured with flexible HARQ-ACK retransmission operation (e.g., provided pdsch-HARQ-ACK-Codebook-r17), the second DCI format indicates a HARQ-ACK information report for previous [Y] cancelled HARQ-ACK feedback transmission occasions within previous [Z] slots/sub-slots (e.g., Y is smaller than X), and a slot indicated by the value of the PDSCH-to-HARQ_feedback timing indicator field in the second DCI format is later than the last HARQ-ACK transmission occasion of the cancelled [X] HARQ-ACK feedback transmissions but no later than a slot for HARQ-ACK information in response to a SPS PDSCH reception, if any, received after a last PDSCH scheduled by a DCI format of the [X] sets of DCI formats and before the second DCI format; or 2) if the UE detects a second DCI format later than a slot for HARQ-ACK information in response to a SPS PDSCH reception received after a last PDSCH scheduled by a DCI format of the [X] sets of DCI formats, the UE is configured with flexible HARQ-ACK retransmission operation (e.g. provided pdsch-HARQ-ACK-Codebook-r17), and the second DCI format indicates a HARQ-ACK information report for previous [Y] cancelled HARQ-ACK feedback transmission occasions within previous [Z] slots/sub-slots (e.g. Y is smaller than X), then the UE multiplexes the corresponding cancelled HARQ-ACK information in a PUCCH or PUSCH transmission in a slot that is indicated by a value of a PDSCH-to-HARQ_feedback timing indicator field in the second DCI format; and 3) otherwise, the UE does not multiplex the corresponding cancelled HARQ-ACK information in a PUCCH or PUSCH transmission.

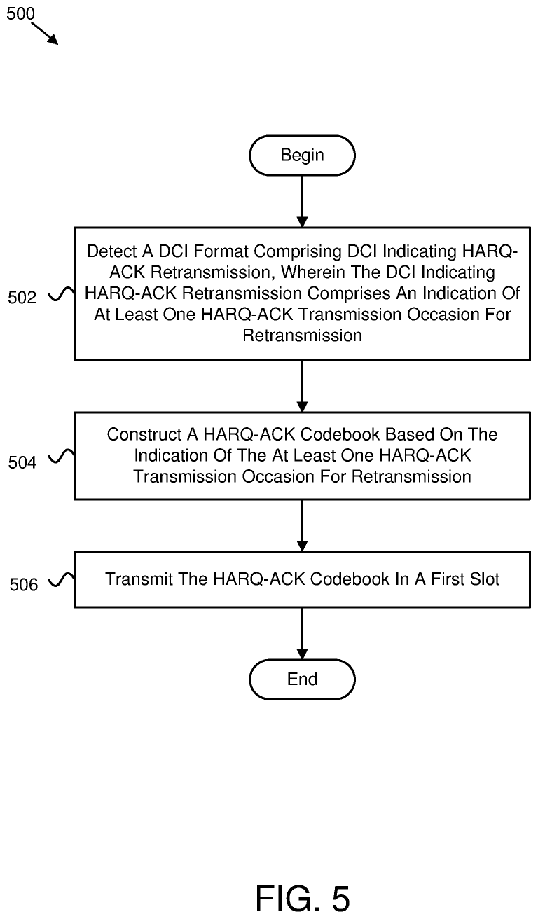

FIG. 5 is a flow chart diagram illustrating one embodiment of a method 500 for constructing a HARQ-ACK codebook. In some embodiments. the method 500 is performed by an apparatus, such as the remote unit 102. In certain embodiments, the method 500 may be performed by a processor executing program code, for example, a microcontroller, a microprocessor, a CPU, a GPU, an auxiliary processing unit, a FPGA, or the like.

In various embodiments, the method 500 includes detecting 502 a DCI format including DCI indicating HARQ-ACK retransmission. The DCI indicating HARQ-ACK retransmission includes an indication of at least one HARQ-ACK transmission occasion for retransmission. In some embodiments. the method includes constructing 504 a HARQ-ACK codebook based on the indication of the at least one HARQ-ACK transmission occasion for retransmission. In certain embodiments, the method includes transmitting 506 the HARQ-ACK codebook in a first slot.

In certain embodiments, the indication of the at least one HARQ-ACK transmission occasion for retransmission comprises timing information of the at least one HARQ-ACK transmission occasion. In some embodiments, the timing information of the at least one HARQ-ACK transmission occasion comprises at least one timing offset value in terms of a number of slots with respect to a second slot associated with timing of the DCI format being detected. In various embodiments, constructing the HARQ-ACK codebook comprises concatenating a first HARQ-ACK codebook corresponding to the at least one HARQ-ACK transmission occasion for retransmission and a second HARQ-ACK codebook scheduled to be multiplexed in the first slot.

In one embodiment, the method 500 further comprises using a default HARQ-ACK codebook as the first HARQ-ACK codebook in response to HARQ-ACK information of the at least one HARQ-ACK transmission occasion for retransmission not being available. In certain embodiments, the method 500 further comprises: receiving information indicating a reference HARQ-ACK codebook size of the at least one HARQ-ACK transmission occasion for retransmission; and appending at least one zero bit to the first HARQ-ACK codebook until a size of the first HARQ-ACK codebook matches the reference HARQ-ACK codebook size in response to the size of the first HARQ-ACK codebook being smaller than the reference HARQ-ACK codebook size. In some embodiments, the DCI format comprises a DL DCI format, and the HARQ-ACK codebook is transmitted in a PUCCH resource indicated by the DL DCI format.

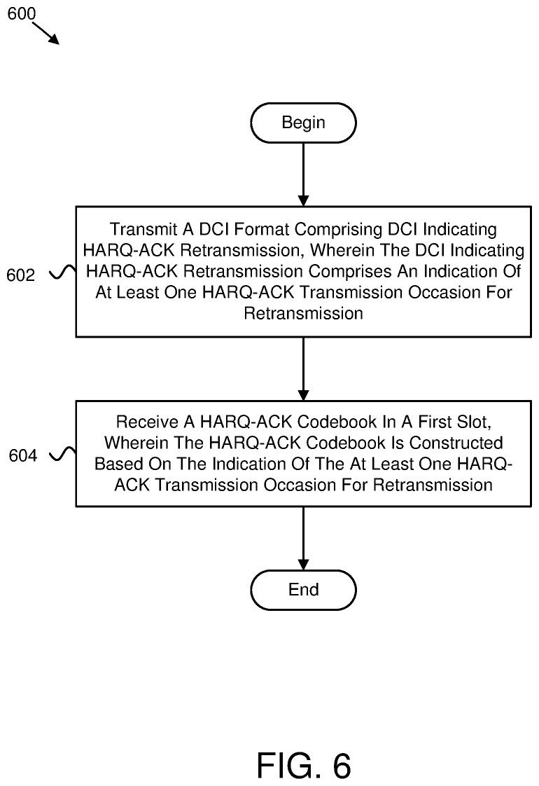

FIG. 6 is a flow chart diagram illustrating another embodiment of a method 600 for constructing a HARQ-ACK codebook. In some embodiments, the method 600 is performed by an apparatus, such as the network unit 104. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes transmitting 602, from a network device, a DCI format including DCI indicating HARQ-ACK retransmission. The DCI indicating HARQ-ACK retransmission includes an indication of at least one HARQ-ACK transmission occasion for retransmission. In some embodiments, the method 600 includes receiving 604 a HARQ-ACK codebook in a first slot. The HARQ-ACK codebook is constructed based on the indication of the at least one HARQ-ACK transmission occasion for retransmission.

In certain embodiments, the indication of the at least one HARQ-ACK transmission occasion for retransmission comprises timing information of the at least one HARQ-ACK transmission occasion. In some embodiments, the timing information of the at least one HARQ-ACK transmission occasion comprises at least one timing offset value in terms of a number of slots with respect to a second slot associated with timing of the DCI format being detected.

In various embodiments, the HARQ-ACK codebook being constructed comprises a first HARQ-ACK codebook corresponding to the at least one HARQ-ACK transmission occasion for retransmission concatenated with a second HARQ-ACK codebook scheduled to be multiplexed in the first slot. In one embodiment, the DCI format comprises a DL DCI format, and the HARQ-ACK codebook is received in a PUCCH resource indicated by the DL DCI format.

In one embodiment, an apparatus comprises: a processor to: detect a DCI format comprising DCI indicating HARQ-ACK retransmission, wherein the DCI indicating HARQ-ACK retransmission comprises an indication of at least one HARQ-ACK transmission occasion for retransmission; and construct a HARQ-ACK codebook based on the indication of the at least one HARQ-ACK transmission occasion for retransmission; and a transmitter to transmit the HARQ-ACK codebook in a first slot.

In certain embodiments, the indication of the at least one HARQ-ACK transmission occasion for retransmission comprises timing information of the at least one HARQ-ACK transmission occasion.

In some embodiments, the timing information of the at least one HARQ-ACK transmission occasion comprises at least one timing offset value in terms of a number of slots with respect to a second slot associated with timing of the DCI format being detected.

In various embodiments, the processor to construct the HARQ-ACK codebook comprises the processor to concatenate a first HARQ-ACK codebook corresponding to the at least one HARQ-ACK transmission occasion for retransmission and a second HARQ-ACK codebook scheduled to be multiplexed in the first slot.

In one embodiment, the processor further to use a default HARQ-ACK codebook as the first HARQ-ACK codebook in response to HARQ-ACK information of the at least one HARQ-ACK transmission occasion for retransmission not being available.

In certain embodiments, the apparatus further comprises a receiver, wherein: the receiver to receive information indicating a reference HARQ-ACK codebook size of the at least one HARQ-ACK transmission occasion for retransmission; and the processor to append at least one zero bit to the first HARQ-ACK codebook until a size of the first HARQ-ACK codebook matches the reference HARQ-ACK codebook size in response to the size of the first HARQ-ACK codebook being smaller than the reference HARQ-ACK codebook size.

In some embodiments, the DCI format comprises a DL DCI format, and the HARQ-ACK codebook is transmitted in a PUCCH resource indicated by the DL DCI format.

In one embodiment, a method at a UE, the method comprises: detecting a DCI format comprising DCI indicating HARQ-ACK retransmission, wherein the DCI indicating HARQ-ACK retransmission comprises an indication of at least one HARQ-ACK transmission occasion for retransmission; constructing a HARQ-ACK codebook based on the indication of the at least one HARQ-ACK transmission occasion for retransmission; and transmitting the HARQ-ACK codebook in a first slot.

In certain embodiments, the indication of the at least one HARQ-ACK transmission occasion for retransmission comprises timing information of the at least one HARQ-ACK transmission occasion.

In some embodiments, the timing information of the at least one HARQ-ACK transmission occasion comprises at least one timing offset value in terms of a number of slots with respect to a second slot associated with timing of the DCI format being detected.

In various embodiments, constructing the HARQ-ACK codebook comprises concatenating a first HARQ-ACK codebook corresponding to the at least one HARQ-ACK transmission occasion for retransmission and a second HARQ-ACK codebook scheduled to be multiplexed in the first slot.

In one embodiment, the method further comprises using a default HARQ-ACK codebook as the first HARQ-ACK codebook in response to HARQ-ACK information of the at least one HARQ-ACK transmission occasion for retransmission not being available.

In certain embodiments, the method further comprises: receiving information indicating a reference HARQ-ACK codebook size of the at least one HARQ-ACK transmission occasion for retransmission; and appending at least one zero bit to the first HARQ-ACK codebook until a size of the first HARQ-ACK codebook matches the reference HARQ-ACK codebook size in response to the size of the first HARQ-ACK codebook being smaller than the reference HARQ-ACK codebook size.

In some embodiments, the DCI format comprises a DL DCI format, and the HARQ-ACK codebook is transmitted in a PUCCH resource indicated by the DL DCI format.

In one embodiment, an apparatus comprises: a transmitter to transmit a DCI format comprising DCI indicating HARQ-ACK retransmission, wherein the DCI indicating HARQ-ACK retransmission comprises an indication of at least one HARQ-ACK transmission occasion for retransmission; and a receiver to receive a HARQ-ACK codebook in a first slot, wherein the HARQ-ACK codebook is constructed based on the indication of the at least one HARQ-ACK transmission occasion for retransmission.

In certain embodiments, the indication of the at least one HARQ-ACK transmission occasion for retransmission comprises timing information of the at least one HARQ-ACK transmission occasion.

In some embodiments, the timing information of the at least one HARQ-ACK transmission occasion comprises at least one timing offset value in terms of a number of slots with respect to a second slot associated with timing of the DCI format being detected.

In various embodiments, the HARQ-ACK codebook being constructed comprises a first HARQ-ACK codebook corresponding to the at least one HARQ-ACK transmission occasion for retransmission concatenated with a second HARQ-ACK codebook scheduled to be multiplexed in the first slot.

In one embodiment, the DCI format comprises a DL DCI format, and the HARQ-ACK codebook is received in a PUCCH resource indicated by the DL DCI format.

In one embodiment, a method at a network device, the method comprises: transmitting a DCI format comprising DCI indicating HARQ-ACK retransmission, wherein the DCI indicating HARQ-ACK retransmission comprises an indication of at least one HARQ-ACK transmission occasion for retransmission; and receiving a HARQ-ACK codebook in a first slot, wherein the HARQ-ACK codebook is constructed based on the indication of the at least one HARQ-ACK transmission occasion for retransmission.

In certain embodiments, the indication of the at least one HARQ-ACK transmission occasion for retransmission comprises timing information of the at least one HARQ-ACK transmission occasion.

In some embodiments, the timing information of the at least one HARQ-ACK transmission occasion comprises at least one timing offset value in terms of a number of slots with respect to a second slot associated with timing of the DCI format being detected.

In various embodiments, the HARQ-ACK codebook being constructed comprises a first HARQ-ACK codebook corresponding to the at least one HARQ-ACK transmission occasion for retransmission concatenated with a second HARQ-ACK codebook scheduled to be multiplexed in the first slot.

In one embodiment, the DCI format comprises a DL DCI format, and the HARQ-ACK codebook is received in a PUCCH resource indicated by the DL DCI format.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
detect a downlink control information (DCI) format comprising DCI indicating hybrid automatic repeat request acknowledgement (HARQ-ACK) retransmission, wherein the DCI indicating HARQ-ACK retransmission comprises an indication of at least one HARQ-ACK transmission occasion for retransmission;
construct a HARQ-ACK codebook based on the indication of the at least one HARQ-ACK transmission occasion for retransmission; and
transmit the HARQ-ACK codebook in a first slot.

2. The UE of claim 1, wherein the indication of the at least one HARQ-ACK transmission occasion for retransmission comprises timing information of the at least one HARQ-ACK transmission occasion.

3. The UE of claim 2, wherein the timing information of the at least one HARQ-ACK transmission occasion comprises at least one timing offset value in terms of a number of slots with respect to a second slot associated with timing of the DCI format being detected.

4. The UE of claim 1, wherein the at least one processor is configured to cause the UE to concatenate a first HARQ-ACK codebook corresponding to the at least one HARQ-ACK transmission occasion for retransmission and a second HARQ-ACK codebook scheduled to be multiplexed in the first slot.

5. The UE of claim 4, wherein the at least one processor is configured to cause the UE to use a default HARQ-ACK codebook as the first HARQ-ACK codebook in response to HARQ-ACK information of the at least one HARQ-ACK transmission occasion for retransmission not being available.

6. The UE of claim 4, wherein the at least one processor is configured to cause the UE to:
receive information indicating a reference HARQ-ACK codebook size of the at least one HARQ-ACK transmission occasion for retransmission; and
append at least one zero bit to the first HARQ-ACK codebook until a size of the first HARQ-ACK codebook matches the reference HARQ-ACK codebook size in response to the size of the first HARQ-ACK codebook being smaller than the reference HARQ-ACK codebook size.

7. The UE of claim 1, wherein the DCI format comprises a downlink (DL) DCI format, and the HARQ-ACK codebook is transmitted in a physical uplink control channel (PUCCH) resource indicated by the DL DCI format.

8. A method at of a user equipment (UE), the method comprising:
detecting a downlink control information (DCI) format comprising DCI indicating hybrid automatic repeat request acknowledgement (HARQ-ACK) retransmission, wherein the DCI indicating HARQ-ACK retransmission comprises an indication of at least one HARQ-ACK transmission occasion for retransmission;
constructing a HARQ-ACK codebook based on the indication of the at least one HARQ-ACK transmission occasion for retransmission; and
transmitting the HARQ-ACK codebook in a first slot.

9. The method of claim 8, wherein the indication of the at least one HARQ-ACK transmission occasion for retransmission comprises timing information of the at least one HARQ-ACK transmission occasion.

10. The method of claim 9, wherein the timing information of the at least one HARQ-ACK transmission occasion comprises at least one timing offset value in terms of a number of slots with respect to a second slot associated with timing of the DCI format being detected.

11. A base station, comprising:
at least one memory; and
at least one processor coupled with the at least one memory and configured to cause the base station to:
transmit a downlink control information (DCI) format comprising DCI indicating hybrid automatic repeat request acknowledgement (HARQ-ACK) retransmission, wherein the DCI indicating HARQ-ACK retransmission comprises an indication of at least one HARQ-ACK transmission occasion for retransmission; and
receive a HARQ-ACK codebook in a first slot, wherein the HARQ-ACK codebook is constructed based on the indication of the at least one HARQ-ACK transmission occasion for retransmission.

12. The base station of claim 11, wherein the indication of the at least one HARQ-ACK transmission occasion for retransmission comprises timing information of the at least one HARQ-ACK transmission occasion.

13. The base station of claim 12, wherein the timing information of the at least one HARQ-ACK transmission occasion comprises at least one timing offset value in terms of a number of slots with respect to a second slot associated with timing of the DCI format being detected.

14. The base station of claim 11, wherein the HARQ-ACK codebook being constructed comprises a first HARQ-ACK codebook corresponding to the at least one HARQ-ACK transmission occasion for retransmission concatenated with a second HARQ-ACK codebook scheduled to be multiplexed in the first slot.

15. The base station of claim 11, wherein the DCI format comprises a downlink (DL) DCI format, and the HARQ-ACK codebook is received in a physical uplink control channel (PUCCH) resource indicated by the DL DCI format.

16. A processor for wireless communication, comprising:
at least one controller coupled with at least one memory and configured to cause the processor to:
detect a downlink control information (DCI) format comprising DCI indicating hybrid automatic repeat request acknowledgement (HARQ-ACK) retransmission, wherein the DCI indicating HARQ-ACK retransmission comprises an indication of at least one HARQ-ACK transmission occasion for retransmission;
construct a HARQ-ACK codebook based on the indication of the at least one HARQ-ACK transmission occasion for retransmission; and
transmit the HARQ-ACK codebook in a first slot.

17. The processor of claim 16, wherein the indication of the at least one HARQ-ACK transmission occasion for retransmission comprises timing information of the at least one HARQ-ACK transmission occasion.

18. The processor of claim 17, wherein the timing information of the at least one HARQ-ACK transmission occasion comprises at least one timing offset value in terms of a number of slots with respect to a second slot associated with timing of the DCI format being detected.

19. The processor of claim 16, wherein the at least one controller is configured to cause the processor to concatenate a first HARQ-ACK codebook corresponding to the at least one HARQ-ACK transmission occasion for retransmission and a second HARQ-ACK codebook scheduled to be multiplexed in the first slot.

20. The processor of claim 19, wherein the at least one controller is configured to cause the processor to use a default HARQ-ACK codebook as the first HARQ-ACK codebook in response to HARQ-ACK information of the at least one HARQ-ACK transmission occasion for retransmission not being available.
